(19) United States
(12) Patent Application Publication
(10) Pub. No.: US 2022/0309941 A1
(43) Pub. Date: Sep. 29, 2022

(54) MARKER EVALUATION SYSTEM, MARKER EVALUATION METHOD, AND RECORDING MEDIUM

(71) Applicant: CASIO COMPUTER CO., LTD., Tokyo (JP)

(72) Inventor: Yutaka ONODERA, Tokyo (JP)

(73) Assignee: CASIO COMPUTER CO., LTD., Tokyo (JP)

(21) Appl. No.: 17/698,603

(22) Filed: Mar. 18, 2022

(30) Foreign Application Priority Data
Mar. 25, 2021 (JP) 2021-051162

(51) Int. Cl. G09B 7/06; G09B 7/02; G09B 5/00

(52) U.S. Cl. CPC G09B 7/06; G09B 7/02; G09B 5/00

(57) ABSTRACT

A marker evaluation system includes: a memory configured to store a program; and at least one processor configured to execute a program stored in the memory, in which the processor is configured to derive at least one of a comparison result obtained by comparing a decided marking result decided based on marking results by a plurality of markers for an identical answer of an identical answerer with a marking result by each of the plurality of markers for the identical answer, and a marking time required for each of the plurality of markers to mark the identical answer, and evaluate each of the plurality of markers based on the at least one of the comparison result and the marking time that has been derived.

This application claims priority based on JP 2021-051162 A filed in Japan on Mar. 25, 2021, the entire contents of which are incorporated herein.

### BACKGROUND

### 1. Technical Field

The disclosure herein relates to a marker evaluation system, a marker evaluation method, and a recording medium.

### 2. Related Art

Writing tests conducted by educational institutions and the like mainly include a selection type test for selecting an answer from among choices and a description type test for describing sentences, numerical expressions, and the like. In the selection type test, numbers and symbols (filled marks in the case of the mark sheet method) written on the answer paper are compared with correct answers and marked.

As a related art, JP 2017-130806 A discloses an image processing device capable of reducing a burden on a marker by acquiring image data of an answer paper on which a sign for manually determining a score is written in advance, identifying the sign in the image data, and aggregating the scores.

In the description type writing test, in answers for an identical question, there is a difference in sentence expression, the number of characters, and the like for each examinee Therefore, it is necessary to consider a difference in nuances and the like in the described answer when marking, and it is difficult to mark mechanically as in the selection type. Therefore, marking is performed by a plurality of markers in a shared manner in some cases.

### SUMMARY

A marker evaluation system according to an aspect of the present invention includes: a memory configured to store a program; and at least one processor configured to execute a program stored in the memory, in which the processor is configured to derive at least one of a comparison result obtained by comparing a decided marking result decided on the basis of marking results by a plurality of markers for an identical answer of an identical answerer with a marking result by each of the plurality of markers for the identical answer, and a marking time required for each of the plurality of markers to mark the identical answer, and evaluate each of the plurality of markers on the basis of the at least one of the comparison result and the marking time that has been derived.

### BRIEF DESCRIPTION OF THE DRAWINGS

FIG. 1 is a diagram illustrating a configuration example of a marking system according to an embodiment;

FIG. 2 is a block diagram illustrating a configuration example of a server device according to the embodiment;

FIG. 3 is a diagram illustrating an example of answer paper data;

FIG. 4 is a diagram illustrating an example of marker information;

FIG. 5 is a diagram illustrating an example of marking information;

FIG. 6 is a diagram illustrating an example of marking mismatching list;

FIG. 7 is a sequence diagram for describing an example of processing performed by the marking system according to the embodiment;

FIG. 8 is a flowchart illustrating an example of answer selection processing;

FIG. 9 is a flowchart illustrating an example of update processing;

FIG. 10 is a flowchart illustrating an example of marker evaluation update processing of FIG. 9;

FIG. 11 is a diagram illustrating a specific example of a relationship between a manner of marking proceeding and evaluation of a marker in the marking system according to the embodiment; and

FIG. 12 is a diagram illustrating an example of evaluation points for a marker and instructions to a marker.

### DETAILED DESCRIPTION

Embodiments of the present invention will be described below with reference to the drawings.

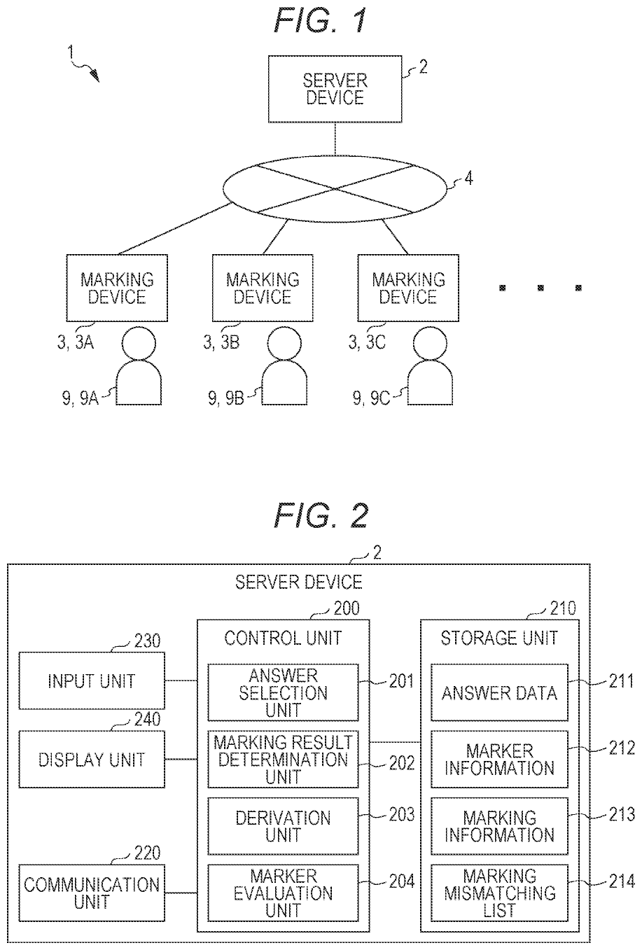

FIG. 1 is a diagram illustrating a configuration example of a marking system according to an embodiment. A marking system 1 illustrated in FIG. 1 includes a server device 2 and a plurality of marking devices 3. Although three marking devices 3A, 3B, and 3C are illustrated in FIG. 1, it is sufficient that the number of marking devices 3 is equal to or greater than three. Hereinafter, the three marking devices 3A, 3B, and 3C are referred to as the marking device 3 when the three marking devices 3A, 3B, and 3C are not distinguished (that is, when it may be any marking device belonging to the marking system 1 including the marking device 3A, the marking device 3B, and the marking device 3C). The server device 2 and the marking device 3 can communicate with each other via a communication network 4 such as the Internet or a dedicated line.

In the marking system 1 of the present embodiment, the server device 2 has an aspect of a storage device that stores answer data (also referred to as answer paper data) obtained by digitizing an answer of an examinee for a description type test, and information regarding a marker who marks the answer. In the marking system 1 of the present embodiment, the server device 2 has an aspect of a marker evaluation device that evaluates a marker on the basis of the marking work performed by the marker. Therefore, the marking system 1 of the present embodiment has an aspect of a marker evaluation system.

The marking device 3 is an information processing device used by a marker 9 to mark an answer of an examinee. The marking device 3 is, for example, a computer connectable to the communication network 4, such as a personal computer or a tablet computer. In the marking system 1 illustrated in FIG. 1, a marker 9A uses the marking device 3A, a marker 9B uses the marking device 3B, and a marker 9C uses the marking device 3C to mark an answer of an examinee. The marker 9A, the marker 9B, and the marker 9C may perform marking in the same marking place or may perform marking in different marking places (for example, home or the like). Hereinafter, the three markers 9A, 9B, and 9C are referred to as the marker 9 when the three markers 9A, 9B, and 9C are not distinguished (that is, when it may be any marker of any marking device belonging to the marking system 1). The marker 9 accesses the server device 2 using the marking device 3 and marks the answer displayed on the display of the marking device 3. The marker 9 inputs a marking result to the marking device 3 to transmit the marking result to the server device 2. The plurality of marking devices 3 used for marking by each of the markers 9 may be, for example, computers of the same model prepared by the performer who has performed the test, or computers that satisfy predetermined requirements individually prepared by each of the markers 9. In the present embodiment, in order to simplify the description, it is assumed that the marking result by the markers 9 for one answer is either correct or incorrect.

FIG. 2 is a block diagram illustrating a configuration example of a server device according to the embodiment. The server device 2 illustrated in FIG. 2 includes a control unit 200, a storage unit 210, a communication unit 220, an input unit 230, and a display unit 240.

The control unit 200 controls the operation of the server device 2 to provide various functions using the server device 2. The control by the control unit 200 is performed, for example, by one or more hardware processors such as a central processing unit (CPU) executing predetermined various programs. The program executed by the hardware processor includes a program that provides various functions related to marking of an answer. Part of the control by the control unit 200 may be performed by, for example, a field programmable gate array (FPGA), an application specific integrated circuit (ASIC), or the like.

The control unit 200 functionally includes an answer selection unit 201, a marking result determination unit 202, a derivation unit 203, and a marker evaluation unit 204.

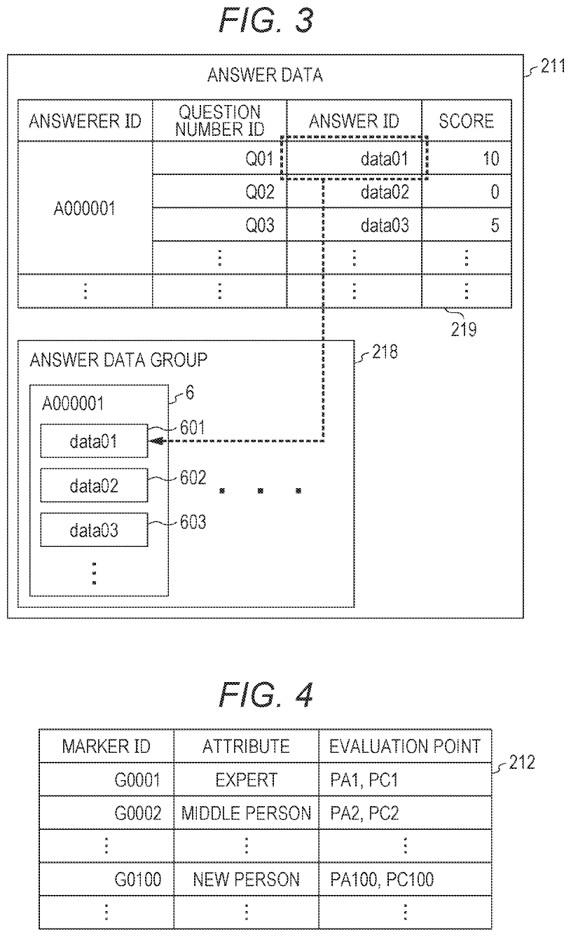

The answer selection unit 201 selects an answer to be marked by the marker 9. The answer selection unit 201 refers to, for example, the marker information 212, the marking information 213, and the marking mismatching list 214 stored in the storage unit 210, and selects an answer to be marked by each marker 9 from among answers whose marking results are not decided. The marker information 212 includes information such as an attribute based on experience as a marker and an evaluation point for the marking work being currently performed for each marker 9. The marking information 213 includes information such as whether or not a marking result is decided and the marker who has performed marking for each answer included in the answer data 211 stored in the storage unit 210. The marking mismatching list 214 includes information indicating answers in which marking results of a plurality of markers do not match with each other for the identical answer and the marking results are not decided. Examples of the answer data 211, the marker information 212, the marking information 213, and the marking mismatching list 214 will be described later with reference to FIGS. 3 to 6.

The marking result determination unit 202 determines whether or not marking results for the identical answer of the identical answerer individually marked by the plurality of markers 9 match. For example, in the marking system 1 of the present embodiment, at least two markers 9 individually mark one answer of one answerer. More specifically, in a case where the marking results of the identical answer of the identical answerer individually marked by the two markers 9 match, the matching marking result is adopted as the marking result (decided marking result) of the answer of the answerer. On the other hand, in a case where the marking results of the two markers 9 do not match, the marking result for the answer of the answerer is determined on the basis of the marking results of the two markers 9 and the marking result of another marker other than the two markers (for example, in a majority decision). For example, the marking result determination unit 202 determines that the marking results match in a case where there are two markers of the answer for which the marking result is decided, and determines that the marking results do not match in a case where there are three markers. In the following description, the fact that the marking results for the identical answer of the identical answerer do not match is referred to as “marking mismatching”.

The derivation unit 203 derives at least one of a comparison result obtained by comparing a decided marking result decided on the basis of marking results by a plurality of markers for the identical answer of the identical answerer and marking results by each of the plurality of markers for the identical answer, and a time required for marking the answer by each of the plurality of markers (hereinafter referred to as “marking time”). For example, the derivation unit 203 derives the marking time on the basis of the time when the answer data to be marked by the marker 9 is transmitted to the marking device 3 and the time when the marking result data is received from the marking device 3. The transfer time required to transfer the answer data from the server device 2 to the marking device 3 and the transfer time required to transfer the marking result data from the marking device 3 to the server device 2 are extremely shorter than the time required for the marker 9 to perform marking by comparing the answer and the correct answer. Therefore, the period from the transmission time of the answer data to the reception time of the data of the marking result described above is substantially the same as the time required for the marking work by the marker 9, and the fairness as the marking time of the plurality of markers 9 that may have different geographical position conditions with respect to the server device 2 is high.

The marker evaluation unit 204 evaluates each of the plurality of markers 9 on the basis of at least one of the above-described comparison result and marking time derived by the derivation unit 203. For example, in a case where the marking results for the identical answer of the identical answerer individually marked by the plurality of markers 9 do not match, the marker evaluation unit 204 evaluates each of the plurality of markers 9 so that the evaluation of the marker whose marking result is different from the decided marking result among the plurality of markers 9 becomes relatively lower than the evaluations of the remaining markers. For example, in a case where the marking time of one marker set as an evaluation target for the identical answer is longer than the marking time of the other markers, the marker evaluation unit 204 performs evaluation such that the evaluation of the one marker set as a target is relatively lower than the evaluations of the other markers. The marker evaluation performed by the marker evaluation unit 204 includes, for example, evaluation related to the concentration ability of the marker and evaluation related to the marking ability. For example, in a case where the marker 9 satisfies a predetermined condition such as taking a break, the marker evaluation unit 204 may change the evaluation such that the evaluation for the marker 9 becomes relatively higher than the evaluation immediately before satisfying the predetermined condition.

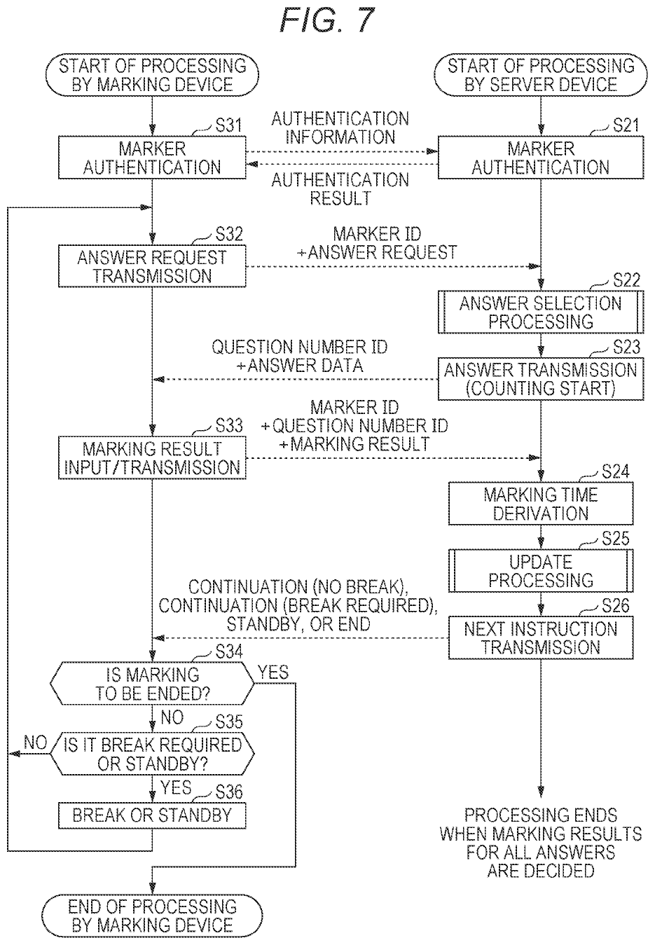

The functions of the respective units of the answer selection unit 201, the marking result determination unit 202, the derivation unit 203, and the marker evaluation unit 204 in the control unit 200 are provided, for example, by causing a processor of the server device 2 to execute a program including processing to be described later with reference to FIGS. 7 to 10.

The storage unit 210 stores, for example, various programs to be executed by a processor that functions as the control unit 200, data to be referred to when the processor executes the programs, created data, and the like. Data stored in the storage unit 210 includes the answer data 211, the marker information 212, the marking information 213, and the marking mismatching list 214 that will be described later with reference to FIGS. 3 to 6. The storage unit 210 includes a main storage device including a random access memory (RAM) and a read only memory (ROM), and an auxiliary storage device such as a hard disk drive (HDD).

The communication unit 220 is a communication interface that connects the server device 2 to the communication network 4 in order to communicate with the marking device 3. The input unit 230 includes, for example, an input device such as a keyboard device or a mouse device. The input unit 230 may include, for example, a scanner device that optically reads an answer described on an answering paper of an examinee and converts the answer into answer data. The display unit 240 includes, for example, a display device such as a liquid crystal display.

Next, examples of the answer data 211, the marker information 212, the marking information 213, and the marking mismatching list 214 will be described with reference to FIGS. 3 to 6.

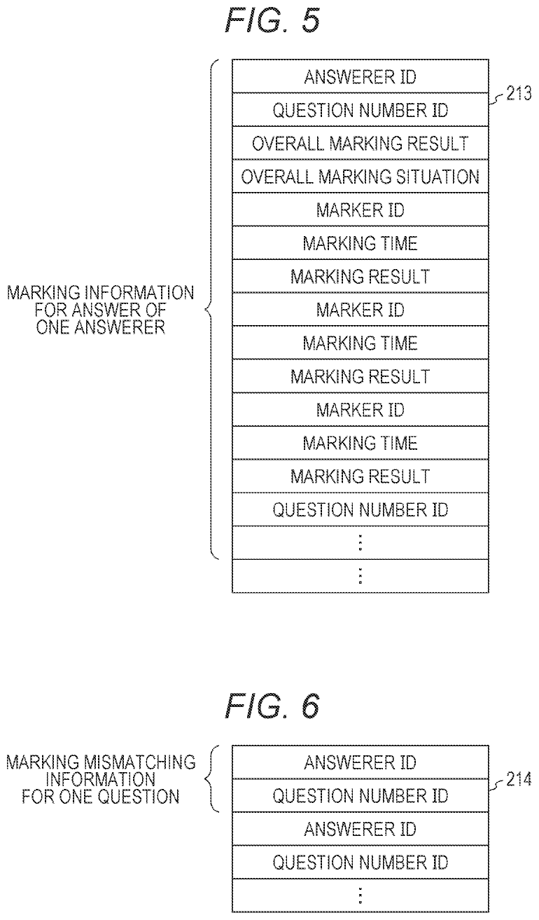

FIG. 3 is a diagram illustrating an example of answer paper data. FIG. 4 is a diagram illustrating an example of marker information. FIG. 5 is a diagram illustrating an example of marking information. FIG. 6 is a diagram illustrating an example of marking mismatching list.

For example, as illustrated in FIG. 3, the answer data 211 includes an answer data group 218 and an answer list 219. The answer data group 218 includes, for example, answer data for each answerer 6 in which answer data to be marked is identified for each answerer. One answer data for each answerer 6 includes a plurality of pieces of answer data 601, 602, 603, . . . obtained as data from an answer sheet of one answerer. One piece of answer data 601 may be data including an answer to one question, or may be data including an answer to each of two or more questions included in one part. Each of the plurality of pieces of answer data 601, 602, 603, . . . in the answer data group 218 is identified by an answerer ID and an answer ID of the answer list 219. The answerer ID is information (for example, the examination number) for identifying the answerer (examinee). The answer ID is information for identifying the question of the answer, and is associated with a question number ID. The question number ID is information for identifying a question among a plurality of questions asked in the test, and is also associated with, for example, correct answer data (not illustrated). In the score field of the answer list 219 exemplified in FIG. 3, scores based on the decided marking result and allocation points for the answers of each question are stored.

The marker information 212 includes, for example, a marker ID, an attribute, and an evaluation point for each marker as illustrated in FIG. 4. The marker ID is information for identifying the marker 9 who accesses the server device 2 using the marking device 3. The attribute is information indicating the degree of experience of the marker 9 as a marker, and is set to, for example, one of three types of “new person (new employee)”, “middle person (experienced employee)”, and “expert” according to the number of answers that the marker 9 has marked in the past. The evaluation point is information indicating the evaluation related to the marking work of the marker 9, and includes, for example, an ability evaluation point PA (PA1, PA2, . . . , PA100, . . . ) used for evaluating the ability of the marker 9 as a marker and a concentration evaluation point PC (PC1, PC2, . . . , PC100, . . . ) used for evaluating the concentration ability of the marker 9.

For example, as illustrated in FIG. 5, the marking information 213 includes information indicating a marking situation for the answer of each question for each answerer. The marking information 213 illustrated in FIG. 5 includes a question number ID, an overall marking result, an overall marking situation, and three sets of marking result information as information indicating the marking situation for the answer of one question. The question number ID is information for identifying the marked answer, and the question number ID and the marked answer are associated with each other by the answer list 219 (see FIG. 3).

The overall marking result (decided marking result) is information indicating a decided marking result for the answer specified by the answerer ID and the question number ID. For example, when the marking result is decided, information indicating that the answer is correct or information indicating that the answer is incorrect is recorded. In the marking system 1 of the present embodiment, for example, at least two markers mark one answer, and in a case where the marking results of the two markers match each other, the marking result is decided as the marking result of one answer to be marked. On the other hand, in a case where the marking results of the two markers for one answer do not match, the third marker is caused to perform marking and the marking result is decided by majority decision.

The overall marking situation is information indicating whether or not the marking for the answer specified by the answerer ID and the question number ID is decided. Each of the three sets of marking result information includes information of a marker ID, a marking time, and a marking result. When the first marker is determined, the marker ID of the marking result information of the first set among the three sets of marking result information is recorded, and information indicating that marking is being performed is recorded in the overall marking situation. When the marking by the first marker is completed, the marking time and the marking result are recorded in the marking result information of the first set. When the second marker is determined, the marker ID of the marking result information of the second set among the three sets of marking result information is recorded, and when the marking by the second marker is completed, the marking time and the marking result are recorded in the marking result information of the second set. In a case where the marking results in the two sets of marking result information match, information indicating that the marking result is decided is recorded in the overall marking situation, and the decided marking result (for example, information indicating that the answer is correct or information indicating that the answer is incorrect) is recorded in the overall marking result. In this case, the server device 2 determines that the marking by the third marker for one answer to be marked is not performed according to the fact that the decided marking result is recorded in the overall marking result.

On the other hand, in a case where the marking results in the two sets of marking result information do not match, the third marker is determined, and the marker ID of the marking result information of the third set among the three sets of marking result information is recorded. When the marking by the third marker is completed, the marking time and the marking result are recorded in the marking result information of the third set. In this case, the server device 2 decides the marking result for one answer to be marked on the basis of the marking result in the three sets of marking result information (for example, in a majority decision), records information indicating that the marking result is decided in the overall marking situation, and records the decided marking result (for example, information indicating that the answer is correct or information indicating that the answer is incorrect) in the overall marking result.

The marking time and the marking result of each marker 9 recorded in the marking information 213 are used for the evaluation of the marker 9 as described later.

In the marking mismatching list 214, marking mismatching information indicating an answer for which the marking results of the two markers do not match and for which the third marker is not determined is recorded. In the marking mismatching list 214 illustrated in FIG. 6, the answerer ID and the question number ID are recorded as the marking mismatching information for one question. In a case where the marking mismatching information is recorded in the marking mismatching list 214, the server device 2 specifies an answer causing the marking mismatching on the basis of the marking mismatching information, and determines a third marker for the answer. After determining the third marker, the server device 2 deletes the marking mismatching information for the answer from the marking mismatching list 214, and records the marker ID of the third marker in the marking result information of the third set of the marking information 213.

The answer data 211, the marker information 212, the marking information 213, and the marking mismatching list 214 are not limited to the configurations described above with reference to FIGS. 3 to 6, and may have other data configurations. One or more pieces of data (information) of the answer data 211, the marker information 212, the marking information 213, and the marking mismatching list 214 may be stored in, for example, an external device that is different from the server device 2 and can communicate with the server device 2.

FIG. 7 is a sequence for describing an example of processing performed by the marking system according to an embodiment. FIG. 7 illustrates processing performed by one marking device 3 and the server device 2 in the marking system 1.

When the marker 9 starts the marking work (marking action), the marker authentication for authenticating the marker 9 is performed between the marking device 3 used by the marker 9 for marking and the server device 2 (steps S31 and S21). For example, the marking device 3 accesses the server device 2 according to a predetermined protocol in the marker authentication (step S31), and transmits authentication information such as the marker ID and the password to the server device 2. In the marker authentication (step S21), the server device 2 authenticates the marker 9 using the authentication information, and transmits the authentication result to the marking device 3. When the authentication is successful in the server device 2, the marker 9 can mark the answer using the marking device 3.

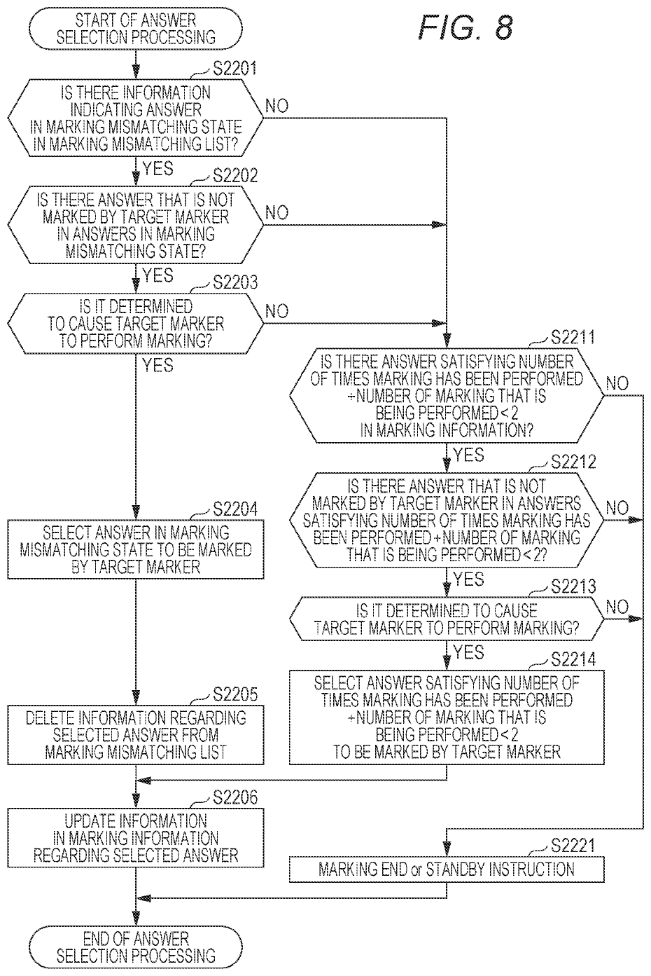

After the authentication succeeds, the marking device 3 transmits the answer request to the server device 2 (step S32). For example, the marking device 3 transmits a packet including the marker ID and the answer request to the server device 2. The server device 2 that has received the answer request performs answer selection processing (step S22) of selecting an answer to be marked by the marker. When there is an answer to be marked, the server device 2 transmits the answer to the marking device 3 that has transmitted the answer request, and starts counting (measuring) the marking time for the answer (step S23). The processing in step S22 is performed by the control unit 200 (more specifically, the answer selection unit 201) of the server device 2. The control unit 200 selects an answer to be marked by the marker with reference to the marking mismatching list 214, the marker information 212, and the marking information 213. An example of specific processing in step S22 will be described later with reference to FIG. 8. Step S23 is performed by the control unit 200 and the communication unit 220 of the server device 2. For example, the control unit 200 generates a packet including the question number ID and the answer data of the selected answer and transmits the packet to the marking device 3 via the communication unit 220. At this time, the control unit 200 (more specifically, the derivation unit 203) of the server device 2 holds, for example, the transmission time. The correct answer data for the answer to be marked by the marker 9 may be transmitted from the server device 2 to the marking device 3, for example, at the timing when the marker authentication succeeds, or may be transmitted together with the answer data in step S32.

The marking device 3 that has received the answer data displays the received answer data on the display device, and urges the marker 9 to perform marking. When the marker 9 performs the marking and inputs the marking result to the marking device 3, the marking device 3 transmits the marking result to the server device 2 (step S33). For example, the marking device 3 transmits a packet including the marker ID, the question number ID, and the marking result to the server device 2.

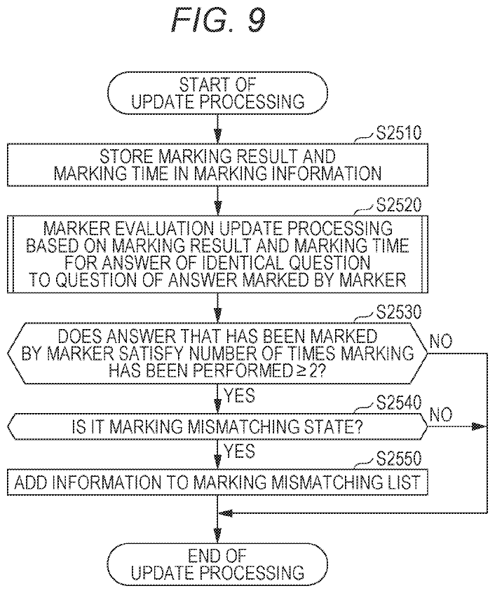

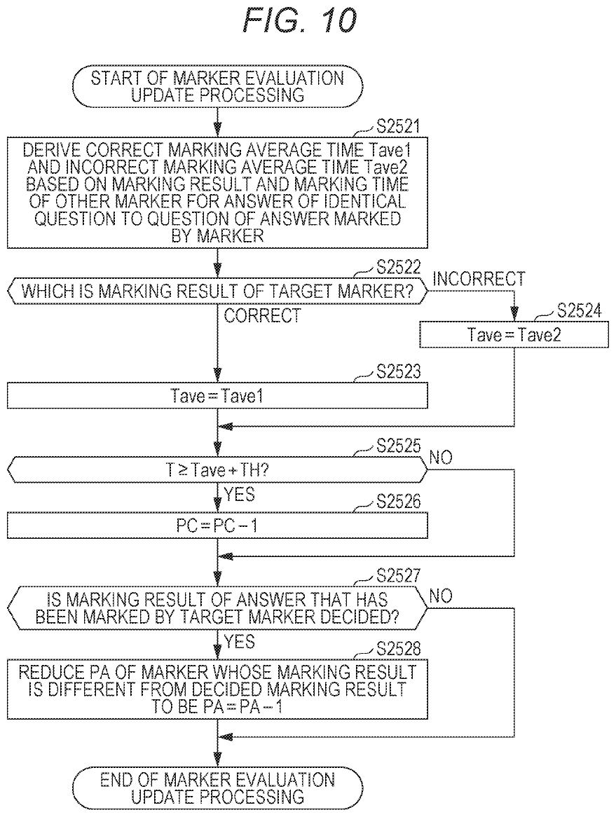

The server device 2 that has received the marking result derives the time (marking time) required for marking by the marker 9 on the basis of the time from the start of the counting in step S23 to the reception of the marking result (step S24). Thereafter, the server device 2 performs update processing (step S25) of updating the evaluation of the marker 9 on the basis of the derived marking time and the marking result, and transmits information including the next instruction for the marker 9 to the marking device 3 (step S26). The processing in step S24 is performed by the control unit 200 (more specifically, the derivation unit 203) of the server device 2. The control unit 200 derives the marking time on the basis of the transmission time held in step S23 and the reception time of the marking result. The processing in step S25 is performed by the control unit 200 (more specifically, the marking result determination unit 202, the derivation unit 203, and the marker evaluation unit 204) of the server device 2. The control unit 200 derives and updates the evaluation of the marker 9 on the basis of the marking time derived in step S24, the received marking time, and the information regarding the marking time for the answer of the identical question in the marking information 213. An example of specific processing in step S25 will be described later with reference to FIGS. 9 and 10. The processing in step S26 is performed by the control unit 200 (more specifically, for example, the marker evaluation unit 204) and the communication unit 220 of the server device 2. The control unit 200 determines the next instruction on the basis of the updated evaluation of the marker 9, the presence or absence of an answer for which a marking result is not decided, the presence or absence of an answer that can be marked by the marker 9, and the like, and transmits a packet including the determined instruction to the marking device 3 via the communication unit 220.

For example, the server device 2 transmits information indicating “continuation (no break)”, “continuation (break required)”, “standby”, or “end” to the marking device 3 as the next instruction. “Continuation (no break)” is information indicating to the marker 9 that the next answer may be marked without a break, and “continuation (break required)” is information indicating to the marker 9 that the marker 9 should mark the next answer after taking a break for a predetermined time. For example, “standby” is information indicating to the marker 9 that the marker 9 should wait because there is no answer that can be marked by the marker 9 at that time, but there is a possibility that marking is required in a case where marking mismatching occurs thereafter. The “end” is, for example, information indicating that the marking results of all the answers are decided or that the marking by the marker 9 is ended on the basis of the evaluation or the like.

On the other hand, the marking device 3 that has received the next instruction from the server device 2 determines whether or not the received instruction is the information indicating the end of the marking (step S34). In a case of the information indicating the end of marking (step S34; YES), the marking device 3 ends the processing related to the marking.

When the received instruction is not the information indicating the end of the marking (step S34; NO), the marking device 3 determines whether or not the received instruction is the information indicating the break required or the standby (step S35). In a case where the information indicates the break required or the standby (step S34; YES), the marking device 3 displays information urging the marker 9 to take a break or stand by (step S36), and transmits the answer request of step S32 after a predetermined break time or standby time has elapsed. In a case where the answer request is transmitted after a predetermined break time or standby time has elapsed, the marking device 3 may include, for example, information indicating that the break or standby has been performed in the answer request. In this case, the server device 2 increases the value of an evaluation point PC regarding the concentration ability of the marker 9, for example, on the basis of the information indicating that the break or the standby included in the answer request has been performed. In a case where it is not the information indicating the break required or the standby (step S35; NO), the marking device 3 omits the processing of step S36 and transmits the answer request of step S32.

The server device 2 repeats the processing of steps S21 to S26 until marking results for all answers to be marked are decided. The marking device 3 repeats the processing of steps S32 to S36 until the information (instruction) indicating the end of the marking is received. Although not illustrated in FIG. 7, for example, in a case where a predetermined operation input is performed by the marker 9, the marking device 3 may transmit a notification including information indicating that the marking is ended (or interrupted) to the server device 2, end the communication with the server device 2, and end the processing related to the marking.

FIG. 8 is a flowchart illustrating an example of answer selection processing. The processing illustrated in FIG. 8 is performed by the control unit 200 (more specifically, the answer selection unit 201) of the server device 2. For example, every time an answer request is received from the marking device 3, the control unit 200 individually performs the answer selection processing illustrated in FIG. 8.

In the answer selection processing illustrated in FIG. 8, the control unit 200 first determines whether or not there is information indicating the answer of the marking mismatching state in the marking mismatching list 214 (step S2201). In a case where there is information indicating the answer of the marking mismatching state (step S2201; YES), the control unit 200 then determines whether or not there is an answer that is not marked by the target marker 9 in the answer in the marking mismatching state (step S2202). In step S2202, for example, the control unit 200 searches the marking information 213 using the answerer ID and the question number ID of the marking mismatching list 214 as key information, and determines the presence or absence of the marking result information in which the marker ID of the target marker 9 is recorded. In a case where there is no marking result information in which the marker ID of the target marker 9 is recorded, the control unit 200 determines that there is an answer that is not marked by the target marker 9 in the answer in the marking mismatching state. In a case where there is an answer that is not marked by the target marker 9 among the answers in the marking mismatching state (step S2202; YES), the control unit 200 determines whether or not to cause the target marker 9 to mark the answer that is not marked (step S2203). In step S2203, the control unit 200 determines whether or not to cause the target marker 9 to perform marking on the basis of, for example, the attribute and the evaluation point of the target marker 9 in the marker information 212. For example, in a case where the attribute of the target marker 9 is “new person” and the evaluation point is lower than a predetermined threshold, the control unit 200 determines not to cause the marker 9 to mark the answer in the marking mismatching state.

In a case of causing the target marker 9 to mark the answer in the marking mismatching state (step S2203; YES), the control unit 200 selects the answer in the marking mismatching state to be marked by the target marker 9 (step S2204), and deletes the information regarding the selected answer from the marking mismatching list 214 (step S2205). In a case where there are a plurality of answers of the marking mismatching state to be marked by the target marker 9, the control unit 200 selects one of the plurality of answers of the marking mismatching state in step S2204.

After the processing of steps S2204 and S2205, the control unit 200 updates information in the marking information 213 related to the selected answer (step S2206), and ends the answer selection processing. In a case of performing the processing of step S2206 following the processing of steps S2204 and S2205, the control unit 200 records the marker ID of the target marker 9 as the marker ID of the third marker in the marking result information of the marking information 213 specified by the answerer ID and the question number ID of the selected answer.

On the other hand, in a case where there is no information indicating the answer of the marking mismatching state in the marking mismatching list 214 (step S2201; NO), or in a case where there is no answer that is not marked by the target marker 9 for the answer in the marking mismatching state (step S2202; NO), the control unit 200 then determines whether or not there is an answer satisfying “number of times marking has been performed+number of marking that is being performed <2” in the marking information 213 (step S2211). Also in a case where the control unit 200 determines not to cause the target marker 9 to mark the answer of the marking mismatching state (step S2203; NO), the control unit 200 performs the determination in step S2211. The number of times marking has been performed is the number of pieces of marking result information in which all of the marker ID, the marking time, and the marking result are recorded among three sets of marking result information for one question in the marking information 213. The number of marking that is being performed is the number of pieces of marking result information in which only the marker ID among three sets of marking result information for one question in the marking information 213 is recorded, and the marking time and the marking result are not recorded. That is, in step S2211, it is determined whether there is an answer that is not determined by the first marker, and whether there is an answer that is determined by the first marker but is not determined by the second marker.

In a case where there is an answer satisfying “number of times marking has been performed+number of marking that is being performed <2” (step S2211; YES), the control unit 200 then determines whether or not there is an answer that is not marked by the target marker 9 in the answer satisfying “number of times marking has been performed+number of marking that is being performed <2” (step S2212). In a case where there is an answer that is not marked (step S2212; YES), the control unit 200 then determines whether or not to cause the target marker 9 to perform marking (step S2213). In step S2213, the control unit 200 determines whether or not to cause the target marker 9 to perform marking on the basis of, for example, the attribute and the evaluation point of the target marker 9 in the marker information 212. For example, in a case where the attribute of the target marker 9 is “expert” and the evaluation is high, the control unit 200 determines not to cause the target marker 9 to perform marking in order to prioritize the marking of the answer in the marking mismatching state or to accumulate marking experience for another marker whose attribute is “new person”.

In a case of causing the marker 9 to mark the answer satisfying “number of times marking has been performed+number of marking that is being performed <2” (step S2213; YES), the control unit 200 selects the answer satisfying “number of times marking has been performed+number of marking that is being performed <2” to be marked by the target marker 9 (step S2214). In a case where there are a plurality of answers of “number of times marking has been performed+number of marking that is being performed <2” to be marked by the target marker 9, the control unit 200 selects one of the plurality of answers in step S2214.

After the processing of step S2214, the control unit 200 updates information in the marking information 213 related to the selected answer (step S2206), and ends the answer selection processing. In a case of performing the processing of step S2206 following the processing of step S2214, the control unit 200 records the marker ID of the target marker 9 as the marker ID of the first or second marker in the marking result information of the marking information 213 specified by the answerer ID and the question number ID of the selected answer. In a case where the target marker 9 is the first marker, the control unit 200 updates the overall marking situation in the marking information 213 to information indicating that marking is being performed.

In a case where there is no answer satisfying “number of times marking has been performed+number of marking that is being performed <2” (step S2211; NO), or in a case where there is no answer that is not marked by the target marker 9 in the answer satisfying “number of times marking has been performed+number of marking that is being performed <2” (step S2212; NO), the control unit 200 determines to instruct the target marker 9 to finish marking or stand by (step S2221), and ends the answer selection processing. Also in a case where the control unit 200 determines not to cause the target marker 9 to mark the answer satisfying “number of times marking has been performed+number of marking that is being performed <2” (step S2203; NO), the control unit 200 performs processing of step S2221, and ends the answer selection processing.

As described above, in the marking system 1 of the present embodiment, the answer to be marked by the target marker 9 in the marker information 212 is selected with reference to the attribute and the evaluation point of the target marker 9. The evaluation point of the marker 9 referred to when selecting the answer is updated in the update processing (step S25) on the basis of the marking time and the marking result.

FIG. 9 is a flowchart illustrating an example of update processing. FIG. 10 is a flowchart illustrating an example of marker evaluation update processing of FIG. 9. The processing exemplified in FIGS. 9 and 10 is performed by the control unit 200 (more specifically, the marking result determination unit 202, the derivation unit 203, and the marker evaluation unit 204) of the server device 2. For example, every time a marking result is received from the marking device 3, the control unit 200 individually performs the update processing illustrated in FIGS. 9 and 10.

In the update processing illustrated in FIG. 9, the control unit 200 first stores the marking result and the marking time derived in step S24 in the marking information 213 (step S2510). For example, the control unit 200 specifies the answerer ID or the like of the answer selected in step S22 on the basis of the marker ID, the question number ID, and the like transmitted from the marking device 3 together with the marking result, and records the marking result and the marking time in association with the marker ID of the target marker 9. In a case where the target marker 9 is the third marker, and the marking result for the answer is decided by the marking result of the marker 9, the control unit 200 updates the record of the overall marking situation to information indicating that the marking result is decided, and records a major result of marking from among marking results of the three people in the overall marking result. In a case where the target marker 9 is the second marker, and the marking result of the marker 9 matches the marking result of the first marker, the record of the overall marking situation is updated to information indicating that the marking result is decided, and the marking result matching the overall marking result is recorded. In a case where the target marker 9 is the second marker and the marking result of the marker 9 does not match the marking result of the first marker, or in a case where the target marker 9 is the first marker, the overall marking situation and the overall marking result are not updated.

Next, the control unit 200 performs the marker evaluation update processing (step S2520) based on another marking result and the marking time for the answer of the identical question to that of the answer marked by the marker 9. The processing in step S2520 is performed by, for example, the derivation unit 203 and the marker evaluation unit 204. The derivation unit 203 derives at least one of a comparison result obtained by comparing the decided marking result for the answer marked by the marker 9 who is the target of the evaluation with the marking result of the marker 9 and the marking time required for the marker 9 to mark the answer. As described above, the marker evaluation unit 204 evaluates each of the plurality of markers 9 on the basis of at least one of the comparison result and marking time derived by the derivation unit 203. In step S2520, the marker evaluation unit 204 updates the evaluation points PC regarding the concentration ability of the target marker 9 on the basis of, for example, the marking time of the target marker 9 for the answer of the identical question and the marking average time of other markers. More specifically, the marker evaluation unit 204 updates the evaluation point PA regarding the marking ability of the target marker 9 on the basis of, for example, the determination result as to whether or not the decided marking result in the answer in which the marking mismatching occurs matches the marking result of the target marker 9. An example of specific processing in step S2520 will be described later with reference to FIG. 10.

Upon completion of the marker evaluation update processing in step S2520, the control unit 200 determines whether or not the answer marked by the marker 9 is “number of times marking has been performed ≥2” (step S2530). In the case of “number of times marking has been performed ≥2” (step S2530; YES), the control unit 200 then determines whether or not the answer is in a marking mismatching state (step S2540). Since the marking result is decided by majority decision in a case where the number of times marking has been performed is “3”, the control unit 200 determines that the answer is in the marking mismatching state only in a case where the number of times marking has been performed is “2” and the two marking results recorded in the marking information 312 are different. In a case where the answer is in the marking mismatching state (step S2540; YES), the control unit 200 adds information regarding the answer to the marking mismatching list 214 (step S2550), and ends the update processing.

On the other hand, in a case where “number of times marking has been performed ≥2” is not satisfied (step S2530; NO), or in a case where “number of times marking has been performed ≥2” is satisfied but the state is not the marking mismatching state (step S2540; NO), the control unit 200 skips the processing of step S2550 and ends the update processing.

As described above, when updating the marking result of the marker 9, the server device 2 exemplified in the present embodiment also updates the evaluation of the marker 9 on the basis of the marking result and the marking time. Hereinafter, an example of the marker evaluation update processing (step S2520) performed by the server device 2 will be described with reference to FIG. 10. The marker evaluation update processing exemplified in FIG. 10 is defined as, for example, a subroutine for the processing exemplified in FIG. 9. Note that, in the following description with reference to FIG. 10, “correct” means that the answer to be marked is correct (correct answer), and “incorrect” means that the answer to be marked is incorrect (incorrect answer).

In the marker evaluation update processing, first, the control unit 200 derives a correct marking average time Tave1 and an incorrect marking average time Tave2 on the basis of the marking results and the marking times of other markers for the answer of the identical question to that of the answer marked by the target marker 9 (step S2521). The other markers are not limited to the other markers who marked the answer marked by the target marker 9, but also include other markers who marked the answers of other answerer to the question of the answer marked by the target marker 9. The correct marking average time Tave1 is an average value of the marking time of the marker who has marked the answer as correct, and the incorrect marking average time Tave2 is an average value of the marking time of the marker who has marked the answer as incorrect.

Next, the control unit 200 determines whether the marking result of the target marker 9 is correct or incorrect (step S2522). When the marking result is “correct” (step S2522; correct), the control unit 200 sets the correct marking average time Tave1 as the marking average time evaluation Tave (step S2523), and determines whether or not the marking time T of the marker 9 is T≥Tave+TH (step S2525). On the other hand, when the marking result is “incorrect” (step S2522; incorrect), the control unit 200 sets the incorrect marking average time Tave2 as the marking average time evaluation Tave (step S2524), and determines whether or not the marking time T of the marker 9 is T≥Tave+TH (step S2525). TH in the determination expression of step S2525 is a time threshold and is set to an arbitrary value of 0 or greater. For example, TH of the determination expression can be set according to the exemplary answer, assumed number of characters in the answer, or the difficulty level of the question.

In a case of T≥Tave+TH (step S2525; YES), the control unit 200 decreases the concentration evaluation point PC related to the evaluation of the concentration by 1 (step S2526).

In a case of T≤Tave+TH (step S2525; NO), or after the concentration evaluation points PC are decreased in step S2526, the control unit 200 determines whether or not the marking result of the answer marked by the target marker 9 is decided (step S2527). In step S2527, the control unit 200 determines whether or not the marking result is decided with reference to, for example, the overall marking situation or the overall marking result of the marking information 213. When the marking result is decided (step S2527; YES), the control unit 200 decreases the ability evaluation point PA regarding the marking ability of the marker 9 having a different marking result from the decided marking result by 1 (step S2528), and ends the marker evaluation update processing. When the marking result is not decided (step S2527; NO), the control unit 200 skips the processing of step S2528 and ends the marker evaluation update processing. When the marker evaluation update processing is ended, the control unit 200 returns to the update processing exemplified in FIG. 9 and performs the determination in step S2530.

As described above, in the marker evaluation update processing of updating the evaluation of the marker 9, in a case where the marking time of the target marker 9 is longer than the average marking time derived based on the marking times of the other markers, a negative point is given to the evaluation point PC regarding the concentration. In a case where a marking mismatching occurs in the answer marked by the target marker 9 and the marking result is decided, a negative point is granted to the evaluation point PA regarding the marking ability of the marker who has indicated a marking result different from the decided marking result among a plurality of markers who have marked the identical answer including the target marker 9. Therefore, it is possible to recognize at an early stage that, for the marker 9 who has received the negative point a plurality of times and the evaluation point has become low, the concentration on marking has decreased and the marking difficulty of the answer exceeds the ability of the marker. Accordingly, in the marking system 1 of the present embodiment, it is possible to instruct the marker 9 to take a break or the like before the marking accuracy or the work efficiency decreases.

The update processing described with reference to FIGS. 9 and 10 may include, for example, processing of recovering the evaluation points of the marker (not illustrated). For example, in a case where the marker 9 takes a break according to an instruction from the server device 2 or voluntarily, a positive point may be granted to the evaluation point PC regarding the concentration ability of the marker 9. As a result, it is possible to prevent repeated break instructions to the marker 9 who has taken a break and has recovered concentration.

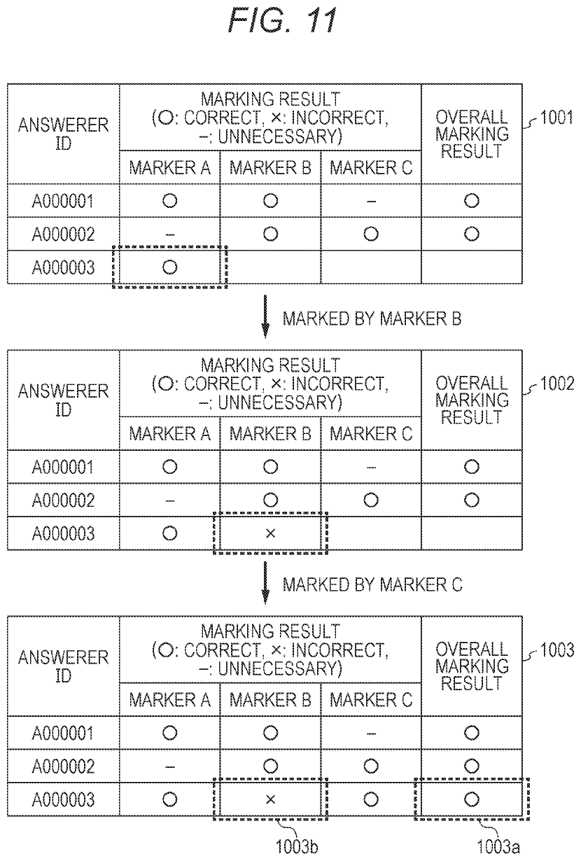

FIG. 11 is a diagram illustrating a specific example of a relationship between a manner of marking proceeding and evaluation of a marker in the marking system according to the embodiment. In order to simplify the description, FIG. 11 illustrates an example of a marking result and an overall marking result of each marker 9 in a case where three markers 9 (marker A, marker B, and marker C) mark answers of three or more answerers.

In a table 1001 of FIG. 11, the two markers 9 of the marker A and the marker B mark the answers of the first answerer whose answerer ID is “A000001”, and the marking results of the two markers 9 are “correct” and match. In this case, the overall marking result for the answer of the first answerer is “correct” supporting the marking results of the two markers 9, and the answer of the first answerer is not marked by the marker C. In a table 1001, the two markers 9 of the marker B and the marker C mark the answers of the second answerer whose answerer ID is “A000002”, and the marking results of the two markers 9 are “correct” and match. Also in this case, the overall marking result for the answer of the second answerer is “correct” supporting the marking results of the two markers 9, and the answer of the second answerer is not marked by the marker A.

In a table 1001, the marker A (one marker 9) marks the answers of the third answerer whose answerer ID is “A000003”, and the marking result is “correct”. When the answer request is transmitted from the marking device 3 of the marker B to the server device 2 in such a marking situation, since there is no answer for which marking mismatching occurs, the server device 2 selects the answer of the third answerer as the answer to be marked by the marker B and causes the marker B to mark the answer. Here, as exemplified in a table 1002 of FIG. 11, if the marking result of the marker B for the answer of the third answerer is “incorrect”, the marking mismatching occurs, and thus the server device 2 records information indicating the answer of the third answerer in the marking mismatching list 214.

Thereafter, when an answer request is transmitted to the server device 2 from the marking device 3 of the marker C who has not marked the answer of the third answerer, the server device 2 selects the answer of the third answerer as the answer to be marked by the marker C and causes the marker C to mark the answer. Here, if the marking result of the marker C is “correct” as illustrated in a table 1003 in FIG. 11, the server device 2 sets the overall marking result for the answer of the third answerer to “correct” by majority decision. In this case, for example, the server device 2 imparts a negative point to the ability evaluation point PA regarding the marking ability of the marker B indicating the marking result 1003b different from the overall marking result 1003a for the answer of the third answerer (step S2528). For example, in a case where the marking time required for the marker C to perform marking of “correct” for the answer of the third answerer is longer than the average of the marking times of the markers in the other marking of “correct” (correct marking average time Tave1), the server device 2 imparts a negative point to the concentration evaluation point PC regarding the concentration ability of the marker C.

Thereafter, marking is performed on the answers of other answerers, and when a marker 9 whose at least one of the evaluation points PA and PC becomes equal to or less than a threshold exists, the server device 2 urges the marker 9 to take a break, for example.

The instruction imparted by the server device 2 to the marker 9 on the basis of the evaluation points PA and PC is not limited to the instruction to urge a break or the standby instruction as described above, and may include other instructions.

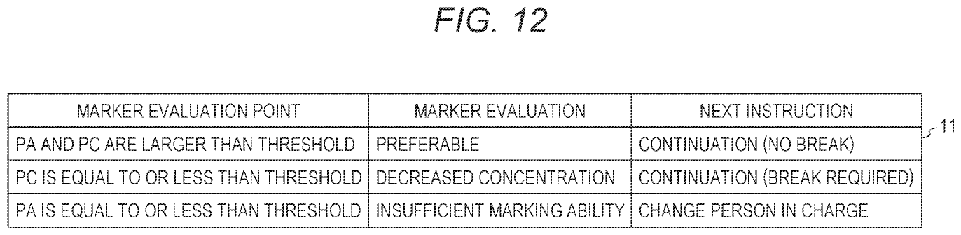

FIG. 12 is a diagram illustrating an example of evaluation points for a marker and instructions to a marker. A table 11 in FIG. 12 shows an example of contents of an instruction in the processing of transmitting the next instruction (step S26) in the processing of the server device 2 exemplified in FIG. 7.

In the processing exemplified in FIG. 10, as the number of times the marking result of the marker 9 is different from the decided marking result increases, the evaluation point PA regarding the marking ability decreases, and as the number of times the marking time is longer than the average marking time increases, the evaluation point PC regarding the concentration ability decreases. For this reason, the marker 9 whose evaluation points PA and PC are larger than the predetermined threshold can be regarded as having high marking accuracy and high work efficiency due to continuous concentration. Therefore, the next instruction to the marker 9 whose updated evaluation points PA and PC are larger than the predetermined threshold is, for example, an instruction indicating that marking may be continued without a break.

On the other hand, the marker 9 whose evaluation point PC regarding the concentration is equal to or less than the threshold has a decreased concentration, which may cause a decrease in marking accuracy and a decrease in work efficiency. Therefore, the next instruction to the marker whose updated evaluation point PC is equal to or less than the threshold is, for example, an instruction indicating that marking may be continued (resumed) after taking a predetermined time break. There is a possibility that the marker 9 whose evaluation point PA regarding the marking ability is equal to or less than the threshold increases the number of times of occurrence of marking mismatching, leading to a decrease in work efficiency. In a case where the marker 9 with a low evaluation point PA becomes the third marker for the answer in the marking mismatching state, there is a possibility that the marking accuracy is lowered. Therefore, the next instruction to the marker 9 whose updated evaluation point PA is equal to or less than the threshold is, for example, an instruction to provide a notification that a person in charge is changed such as changing the answer to be marked to the answer of the question with low marking difficulty, or not selecting the third marker for the answer in the marking mismatching state.

The next instruction to the marker 9 based on the evaluation of the marker 9 is not limited to the instruction shown in the table 11 of FIG. 12, and can be changed as appropriate. For example, in a case where the marking time of the marker 9 is longer than the marking time of other markers, it is conceivable that the marking ability of the marker 9 is insufficient with respect to the difficulty of marking and it takes time to correctly determine the intention of the answer in addition to the decrease in concentration. Therefore, the server device 2 may evaluate the marker 9 by integrating the marking time of the marker 9 and the relationship between the marking result of the marker 9 when the marking mismatching occurs and the decided marking result. In the evaluation of the marker 9, for example, the evaluation criteria (for example, the threshold TH related to the determination in step S2525 related to the marking time described above with reference to FIG. 10) may be changed for each attribute of the marker. For example, by making the evaluation criteria for the “expert” who has abundant marking experience stricter than the evaluation criteria for the “new person” who has little marking experience, it is possible to suppress a decrease in marking accuracy due to inadvertent marking errors or the like caused by the marking experience of the expert marker 9. The value of the negative point imparted in the evaluation of the marker 9 may be changed for each attribute of the marker.

As described above, the marking system 1 of the present embodiment performs marking for one answer in a description type test by two or more markers 9, and decides the marking result by majority decision of the marking results of the two or more markers 9. At this time, in the marking system 1 of the present embodiment, the concentration and the marking ability of the marker 9 with respect to the marking work are evaluated on the basis of at least one of the comparison result between the decided marking result for the answer for which the marking mismatching occurs and the marking result of the marker 9 with respect to the answer and the relationship between the marking time required for marking by the marker 9 and the marking time of another marker with respect to the answer of the identical question to that of the answer marked by the marker 9. With such an evaluation, it is possible to recognize at an early stage that the concentration or the marking ability of the marker 9 is low, and thus, it is possible to take appropriate measures such as urging the marker 9 whose evaluation has been lowered to take a break before causing a decrease in marking accuracy or a decrease in work efficiency. Accordingly, the marking system 1 of the present embodiment having the aspect of the marker evaluation system can maintain the accuracy of marking and the work efficiency in the description type test. The marking system 1 having an aspect of such a marker evaluation system is particularly useful for ensuring the fairness of the marking in the description type test having many answers to be marked and in which quick and accurate marking of the answers is required.

The above-described embodiment is a specific example for facilitating understanding of the invention, and the present invention is not limited to the above-described embodiment. The marker evaluation system, the marker evaluation method, and the recording medium according to the present invention can be variously modified and changed without departing from the scope of the claims.

For example, the server device 2 of the marking system 1 described above with reference to FIGS. 1, 2, 7, and the like may be replaced with a configuration in which two or more individual devices are combined. For example, the marking system 1 having an aspect of the marker evaluation system may include a first server device (storage device) that stores the answer data 211 and a second server device that includes a processor functioning (operating) as the control unit 200 and performs management of marking, evaluation of the marker, and the like. The functions of the respective units of the answer selection unit 201, the marking result determination unit 202, the derivation unit 203, and the marker evaluation unit 204 described above with reference to FIG. 2 may be distributed to two or more separate server devices (information processing devices). That is, the marker evaluation system according to the present invention may be a system that is additionally provided to an existing marking system that performs marking using the plurality of marking devices 3. In a case where the marking evaluation system is additionally provided in the existing marking system, for example, the introduction cost can be suppressed to a low amount.

The processing performed by the server device 2 described above with reference to FIG. 7, the answer selection processing described above with reference to FIG. 8, and the update processing described above with reference to FIGS. 9 and 10 are merely examples of processing performed by the marking system 1 having an aspect of the marker evaluation system. These processes described above can be appropriately changed without departing from the gist of the present invention. For example, a plurality of individual processes may be performed as one integrated process, or the order of the processes may be changed. Furthermore, as described above, the update processing of updating the evaluation of the marker 9 may include, for example, processing of increasing the evaluation of the marker 9 who takes a break according to an instruction from the server device 2 or voluntarily.

The method of evaluating the marker is not limited to, for example, the above-described evaluation using the evaluation point PC regarding the concentration and the evaluation point PA regarding the marking ability, and can be appropriately changed. In addition, the method of deriving the evaluation point in the method of evaluating the marker using the evaluation point is not limited to the above-described method of imparting the negative point, and can be appropriately changed. In addition, the evaluation criteria of the marker are not limited to the above-described evaluation criteria, and can be appropriately changed. Furthermore, the method of using the evaluation by the marker is not limited to the above-described use method, and can be appropriately changed.

In addition, in the above-described embodiment, the case where the marking result by the marker is two ways of correct or incorrect is taken as an example, but the marking result may be three or more ways. For example, there is a case where there is an error in a part of the answer (for example, in a case where the calculation is correctly performed in the middle of the calculation problem, or the like), and in such a case, an evaluation different from the correct answer (full point) and the incorrect answer (0 points) (a partial point lower than the score in the case of the correct answer is imparted) may be performed. In addition, the marking result by the marker is not limited to the evaluation with a numerical value such as a score, and may be, for example, a result of evaluating the superiority or inferiority of the answer in two or more evaluation stages (for example, three stages of A evaluation, B evaluation, and C evaluation) on the basis of the power of expression, development, and the like of the sentence.

When marking mismatching occurs for one answer in a case where there are three or more marking results, there are a case where a marking result different from a decided marking result among marking results by a plurality of markers for the one answer is close to the decided marking result and a case where the marking result is greatly deviated from the decided marking result. For this reason, for example, when evaluating a marker who has performed different marking on the basis of the marking result, in a case where the deviation between the marking result of the marker and the decided marking result is large, the lowering range of the evaluation may be increased as compared with the case where the deviation is small. For example, in a case where the decided marking result for the answer evaluated in three stages of the A evaluation, the B evaluation, and the C evaluation is the A evaluation, the lowering width of the evaluation of the marker in a case where the marking mismatching occurs and the marker who has performed the evaluation different from the decided marking result performs the C evaluation is made larger than the lowering width of the evaluation of the marker in a case where the marker has performed the B evaluation. In this manner, it is possible to more appropriately evaluate the marking ability for the marker who performs marking different from the decided marking result and has a large deviation between the marking result and the decided marking result.

In a case where there are three or more marking results, when the marking result for the answer for which marking mismatching occurs is determined by the majority decision as described above, a difference occurs in the number of markers related to the marking. For example, in a case where the marking results includes the A evaluation and the B evaluation for the answer evaluated in three stages of the A evaluation, the B evaluation, and the C evaluation, when the third marker performs the A evaluation or the B evaluation, the marking result is decided. However, in a case where the third marker performs the C evaluation, since it cannot be determined by majority decision, marking by the fourth marker is required. In order to prevent such a decrease in marking efficiency due to an increase in the number of markers related to marking for one answer, for example, the maximum number of markers in a case where the marking mismatching occurs may be determined, and the marking result for the answer in which the marking mismatching occurs may be determined using the average of the marking results by the markers of the maximum number of markers or the like. Such a method may be, for example, a method in which the marking result is decided by majority decision in a case where the marking result is decided by majority decision before the maximum number of markers is reached, and the marking result is decided on the basis of an average of the marking results of the markers in a case where the marking result cannot be decided by majority decision even if the maximum number of markers is reached.

What is claimed is:

1. A marker evaluation system comprising:
a memory configured to store a program; and
at least one processor configured to execute a program stored in the memory,
wherein the processor is configured to
derive at least one of a comparison result obtained by comparing a decided marking result decided based on marking results by a plurality of markers for an identical answer of an identical answerer with a marking result by each of the plurality of markers for the identical answer, and a marking time required for each of the plurality of markers to mark the identical answer, and
evaluate each of the plurality of markers based on the at least one of the comparison result and the marking time that has been derived.

2. The marker evaluation system according to claim 1, wherein
the decided marking result is decided by a majority decision of the marking result by the plurality of markers.

3. The marker evaluation system according to claim 1, wherein
the processor performs evaluation in a manner that an evaluation of a marker who has performed marking that does not match the decided marking result for the identical answer is relatively lower than an evaluation of a marker who has performed marking that matches the decided marking result.

4. The marker evaluation system according to claim 1, wherein
the processor performs evaluation in a manner that an evaluation of a marker whose marking time is relatively long in marking times by each of the plurality of markers for the identical answer is relatively lower than an evaluation of a marker whose marking time is relatively short.

5. The marker evaluation system according to claim 1, wherein
the processor gives an instruction of any one of break required, standby, and end to a marker whose evaluation is relatively low among the plurality of markers or a marker whose evaluation reaches a threshold.

6. The marker evaluation system according to claim 1, wherein
the processor evaluates each of the plurality of markers based on a comparison between an average of marking times of all the markers for an identical question and the marking times of each of the plurality of markers.

7. The marker evaluation system according to claim 1, wherein
if a marking action by each of the plurality of markers is performed using a server device communicable with a marking device used for marking by the plurality of markers,
then the processor derives the marking time by acquiring a time at which the server device transmits the identical answer to be marked by the plurality of markers to the marking device and a time at which the server device receives marking results of each of the plurality of markers from the marking device.

8. The marker evaluation system according to claim 1, wherein evaluation criteria are changed according to an attribute of each of the plurality of markers.

9. A marker evaluation method comprising, by a computer:
deriving at least one of a comparison result obtained by comparing a decided marking result decided based on marking results by a plurality of markers for an identical answer of an identical answerer with a marking result by each of the plurality of markers for the identical answer, and a marking time required for each of the plurality of markers to mark the identical answer; and
evaluating each of the plurality of markers based on the at least one of the comparison result and the marking time that has been derived.

10. A non-transitory computer-readable recording medium storing a program for causing a computer to execute:
deriving at least one of a comparison result obtained by comparing a decided marking result decided based on marking results by a plurality of markers for an identical answer of an identical answerer with a marking result by each of the plurality of markers for the identical answer, and a marking time required for each of the plurality of markers to mark the identical answer; and
evaluating each of the plurality of markers based on the at least one of the comparison result and the marking time that has been derived.
